(19) United States
(12) Patent Application Publication
(10) Pub. No.: US 2009/0244377 A1
(43) Pub. Date: Oct. 1, 2009

(54) Display controller for screens with user-defined frames

(75) Inventors: Siao-Huei Lai, Taipei County (TW); Lung-Teng Hsu, Taipei County (TW)

Correspondence Address: BACON & THOMAS, PLLC, 625 SLATERS LANE, FOURTH FLOOR, ALEXANDRIA, VA, 22314-1176, US

(73) Assignee: Tenx Technology Inc., Taipei County (TW)

(21) Appl. No.: 12/078,224

(22) Filed: Mar. 28, 2008

(51) Int. Cl. H04N 5/45; G01S 1/00

(52) U.S. Cl. 348/565; 342/357.06; 348/E05.112

(57) ABSTRACT

The present invention discloses a display controller for screens with user-defined frames, comprising: a first image source to provide first image data; a second image source to provide second image data; an information converter unit in connection with said first and second image sources, to convert said first and second image data into digital data; an image processor unit in connection with said information converter unit to add said digitized first and second image data, to generate a picture-in-picture (PIP) image with one main screen and at least one subscreen to be display in a display device; and a frame generator to generate, according to the definitions of a user, a frame for said at least one subscreen to enclose said subscreen when displayed. The invented display controller generates PIP images with user-defined frames.

### FIELD OF THE INVENTION

The present invention relates to a display controller for screens with user-defined frames, especially to a display controller to generate the PIP screens with user-defined frames.

### BACKGROUND OF THE INVENTION

The technical breakthroughs in the computer displaying devices have generated the great needs in the digital displaying devices. Displaying devices that display only one frame are not attractive to the users any more. As a result, the PIP (picture in picture) displays have become the major trend in the market of the displaying devices.

Generally speaking, the PIP function is a screen editing function wherein a main screen and a plurality of subscreens are shown in the screen of the display device. In a typical PIP screen, the main screen is defined by the computer, and the subscreens are defined by other signal sources, such as the cable TV, the VTR, the DVD player etc.

There are, however, several unsolved problems left in the known PIP technology.

First of all, under the current PIP displaying technology, both of the main screen and the subscreens are displayed in a rectangular frame. The subscreens are displayed on top of the main screen. The boring rectangular frame of the subscreens is not only unattractive to the users but also limits functionality of the PIP display device. In addition, in the conventional technology the subscreens are designed to cover the images in the main screen. In order to see the contents of the main screen, the user has to reduce or remove the subscreens that block the relative parts of the main screen.

Thus, it is necessary to provide a novel display controller that generates a main screen and a plurality of subscreens with a frame not limited to the rectangular shape.

It is also necessary to provide a display controller that generates a main screen and a plurality of subscreens with a user-defined frame.

It is also necessary to provide a display controller that generates a main screen and a plurality of subscreens with dynamic frames.

It is also necessary to provide a display controller that generates a main screen and a plurality of subscreens wherein the displaying contents of the main screen may penetrate the subscreens.

### OBJECTIVES OF THE INVENTION

The objective of the present invention is to provide a novel display controller that generates a main screen and a plurality of subscreens with a frame not limited to the rectangular shape.

Another objective of the invention is to provide a display controller that generates a main screen and a plurality of subscreens with a user-defined frame.

Another objective of the invention is to provide a display controller that generates a main screen and a plurality of subscreens with dynamic frames.

Another objective of the invention is to provide a display controller that generates a main screen and a plurality of subscreens, wherein the displaying contents of the main screen may penetrate the subscreens.

### SUMMARY OF THE INVENTION

According to the present invention, a display controller for screens with user-defined frames is disclosed. The display controller of this invention is able to generate screens with user-defined frames, and comprises: a first image source, a second image source, an information converter unit, an image processor unit, and an image frame generator. The first and second image sources are connected to the information converter unit. The image processor unit is also connected to the information converter unit. The frame generator is connected to the image processor unit. The display controller for screens with user-defined frame of this invention may further be connected to a display unit, so to generate the screens with user-defined frames in the display unit.

More specifically speaking, the first image source functions to provide first image data and the second image source functions to provide second image data. The separate image data may be the audio-video data or image data containing other types of data. In addition, the information converter unit functions to convert the first image data and the second image data into digital data. If necessary, an information decoder unit may be provided, to decode the digital data that are converted from the first image data and the second image data. The frame generator functions to generate the frames of the images to be displayed, according to the definitions given by the user. The image processor unit functions to process the adding of the decoded first image data, the second image data and the frames generated by the frame generator, so to generate in the display unit a main screen and at least one subscreen, whereby the subscreen is displayed in the frame defined by the user.

There are no particular limitations in the type of the image data to be processed in the present invention. A preferred example of the image data is the video signals. In the application, the image data may include voice signals, text signals and other data. The information decoder unit is not limited to any particular type. A preferred example of the information decoder is the video signal decoder. The information converter unit of the present invention is not limited to any particular type. A preferred example of the information converter unit is the analog-to-digital converter. In addition, the image processor unit of the invention is not limited to any particular type. A preferred example is the PIP image processor unit.

The frame generated by the frame generator of the present invention may be any shape that encloses an area in the screen of the display device. Examples of the shape of the frames are a dynamically variable shape, a sizable shape or a randomly defined shape. Here, the “dynamically variable shape” pertains to a frame that may dynamically change, in a manner, for example, simulating the portrait of a cartoon character. The frame may vary in line with the actions of the cartoon character. The frame generated by the frame generator may contain an enclosing edge line of predetermined widths or undetermined widths. The edge line may contain decorative patterns, colors or other designs. It is recommended that a plurality of pattern of the frame is provided, so that the user may select from the provided patterns from the user interface. It is also possible to provide in the user interface a tool allowing the user to randomly define the shape of the frames.

The display controller of the present invention may further include an information decoder unit, to decode the second image data that have been converted into the digital data. The information decoder unit connects the information converter unit at its one side and the image processor unit at another side. In addition, the display device of the present invention is not limited to any particular type. A preferred example is the displaying panel. More preferred examples are the liquid crystal display panel, the thin film transistor liquid crystal display etc. The functions provided by the display device may include the mirror function. The display device may further include a memory in connection with the image processor unit, to function as a buffer memory to store the image data to be added. The memory may also be provided in the display controller and is preferably a dynamic random access memory.

The display controller of the present invention may further include a third image source, in order to provide third image data. The third image data are not limited to any particular type. The preferred examples of the third image data include the video signals and the video-audio signals. The third image data are preferably the digital signals. Further image sources may be included in the display controller of the present invention, so that more image data may be provided. These image data may be transmitted by the video signals or the video-audio signals and are preferably the digital signals.

The display controller of the present invention preferably includes a GPS receiver, in connection with the third image source, to provide the third image data. Preferably the third image data are generated by the combination of the GPS receiver and an operation unit. The GPS receiver may be connected to the operation unit, which in turn is connected with the third image source. The operation unit preferably includes an operational processor, two dynamic random access memories and a NAND flash memory. The operation processor is connected with the two dynamic random access memories and the NAND flash memory. The operation processor is not limited to any particular type. Preferred examples of the operational processor are the central processing unit and the microprocessor.

The display controller of the present invention may further include a terrestrial digital multimedia broadcast module, in connection with the third image source, to provide the third image data. It may further include a satellite digital multimedia broadcast module, in connection with the third image source, to provide the third image data. The display controller may further include a radio receiver to provide audio signals to the display device. The contents of the audio signals may thus be output from the speakers in connection with the display device. The radio receiver is not limited to any particular type. Preferable examples are the FM radio receiver, the AM radio receiver and the digital multimedia audio device.

These and other objectives and advantages of the present invention may be clearly understood from the detailed description by referring to the following drawings.

### BRIEF DESCRIPTION OF THE DRAWINGS

FIG. 1 shows the block diagram of the first embodiment of the display controller for screens with user-defined frames of the present invention.

FIG. 2 shows the block diagram of the second embodiment of the display controller for screens with user-defined frames of the present invention.

FIG. 3 shows the block diagram of the third embodiment of the display controller for screens with user-defined frames of the present invention.

FIG. 4 shows the block diagram of the fourth embodiment of the display controller for screens with user-defined frames of the present invention.

FIG. 5 shows the block diagram of the fifth embodiment of the display controller for screens with user-defined frames of the present invention.

FIG. 6 shows the block diagram of the sixth embodiment of the display controller for screens with user-defined frames of the present invention.

FIG. 7 shows the block diagram of the seventh embodiment of the display controller for screens with user-defined frames of the present invention.

FIG. 8 shows the block diagram of the eighth embodiment of the display controller for screens with user-defined frames of the present invention.

FIG. 9 shows the block diagram of the ninth embodiment of the display controller for screens with user-defined frames of the present invention.

FIG. 10 shows the block diagram of the ninth embodiment of the display controller for screens with user-defined frames of the present invention.

### DETAILED DESCRIPTION OF THE INVENTION

The followings are detailed descriptions to the preferred embodiments of the present invention. Those skilled in the art may realize the advantages and effects of this invention from the descriptions of the preferred embodiments. This invention may also be realized by those deviations of the embodiments. Details of the preferred embodiments may also be modified without deviating from the scope of the present invention.

### Embodiment 1

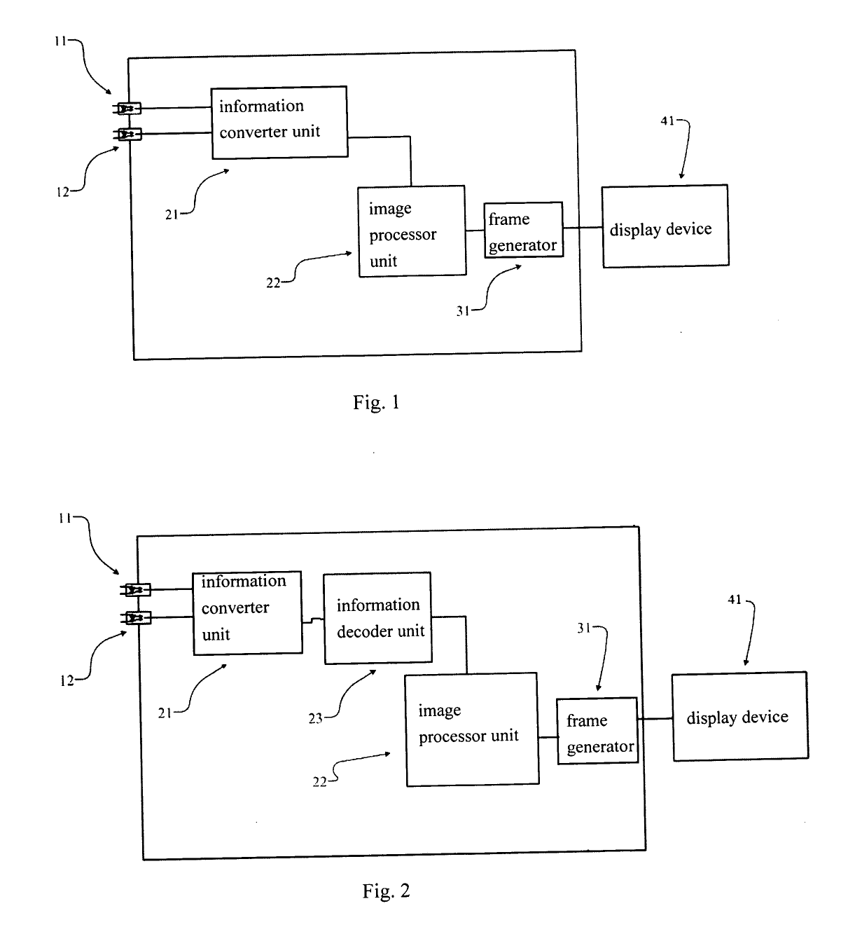

FIG. 1 shows the block diagram of the first embodiment of the display controller for screens with user-defined frames of the present invention. As shown in the figure, in this first embodiment, the display controller for screens with user-defined frames of the present invention includes a first image source 11, a second image source 12, an information converter unit 21, an image processor unit 22 and a frame generator 31 and is connected to a display device 41. In them, the first image source 11 and the second image source 12 are separately connected to one terminal of the information converter unit 21, with its other terminal connected to the image processor unit 22. The frame generator 31 is also connected to the image processor unit 22. In this embodiment, the display unit 41 is a liquid display panel.

The first image data is provided through the first image source 11, and the second image data is provided through the second image source 12. In the present embodiment, both the first and second image data are video signals. When the first and second image data enter the display controller, they are first provided to the information converter unit 21 to be converted into digital data. Also in this embodiment the information converter unit 21 is an analog-to-digital converter. The frame generator 31 is able to generate, according to the instructions of the user or the predetermined parameters, frames for the first and the second image data to be displayed in the display device 41. The parameters used to generate the frames may include the definitions such as the size, shape, pattern, position, quality etc. of the image to be display and the related images.

Thereafter, the image data are provided to the image processor unit 22, to conduct the adding of the images. In this embodiment, the image processor unit 22 is a PIP image processing unit. The PIP image processing unit 22 of this embodiment conducts the adding operations of the first image data, the second image data and the frames generated by the frame generator 31, so to generate the PIP images with the user-defined frames to be displayed in the display device 41. Generally peaking, the PIP images include a main screen and at least one subscreen. The main screen is the background image generated by the operation system of the computer device in connection with the display device. Under such circumstance, the frame of the main screen is the frame of the display device 41. However, in other cases, a particularly defined frame may be given to the main screen. The computer device that may be used in the present invention includes the personal computer, the server and the notebook computer. It may also be any home appliance, office appliance, factory equipment or amusement tools in which the computer is used.

In the last stage, the added image is provided to the display device 41 for display. The display device 41 displays the PIP image with the main screen and the subscreen with the user-defined frames. The image as added by the image processor unit 22 has a main screen and a subscreen in it. The subscreen has a frame with the dynamically variant shape, a scalable shape or a randomly selected shape.

The frame generated by the frame generator 31 may be any shape that encloses an area of the screen of the display device. Preferred examples of the frame include the dynamically variant shape, the scalable shape or any randomly selected shape. The frame generated by the frame generator may contain an enclosing edge line of predetermined widths or undetermined widths. The edge line may contain decorative patterns, colors or other designs. It is recommended that a plurality of pattern of the frame is provided, so that the user may select from the provided patterns from the user interface. It is also possible to provide in the user interface a tool allowing the user to randomly define the shape of the frames.

In comparison, the subscreens of the conventional PIP screens are always defined by a rectangular frame. The present invention is advantageous, since the frame of the main screen and the subscreens is not limited to the rectangular shape. The shape of the frame may be variable and scalable, without any limitation.

### Embodiment 2

FIG. 2 shows the block diagram of the second embodiment of the display controller for screens with user-defined frames of the present invention. In this figure the components identical to those in FIG. 1 are labeled with the same reference numbers. As shown in the figure, in this first embodiment, the display controller for screens with user-defined frames of the present invention includes a first image source 11, a second image source 12, an information converter unit 21, an information decoder unit 23, an image processor unit 22 and a frame generator 31 and is connected to a display device 41. In them, the first image source 11 and the second image source 12 are respectively connected to one terminal of the information converter unit 21, with its other terminal being connected to the information decoder unit 23. The information decoder unit 23 is in connection with the image processor unit 22. The frame generator 31 is also connected to the image processor unit 22. In this embodiment, the display unit 41 is a liquid display panel.

The first image data are provided through the first image source 11 and the second image data are provided through the second image source 12. In the present embodiment both the first and second image data are video signals. When the first and second image data enter the display controller, they are first provided to the information converter unit 21 to be converted into digital data. Also in this embodiment the information converter unit 21 is an analog-to-digital converter. In this embodiment the information converter unit 21 is an analog-to-digital converter.

The frame generator 31 is able to generate, according to the instructions of the user or the predetermined parameters, frames for the first and the second image data to be displayed in the display device 41.

Thereafter, the digitized image data are provided to the information decoder unit 23 for decoding. In this embodiment, the information decoder unit 23 is a video signal decoder. In the following, the image data are provided to the image processor unit 22, to conduct the adding process. In this embodiment, the image processor unit 22 is a PIP image processing unit. The PIP image processing unit 22 of this embodiment conducts the adding operations of the first image data, the second image data and the frames generated by the frame generator 31, so to generate the PIP images with the user-defined frames to be displayed in the display device 41.

Lastly, the added image is provided to the display device 41 for display. The display device 41 displays the PIP image with the main screen and the subscreen with the user-defined frames. The image as added by the image processor unit 22 has a main screen and a subscreen in it. The subscreen has a frame with the dynamically variant shape, a scalable shape or a randomly selected shape.

### Embodiment 3

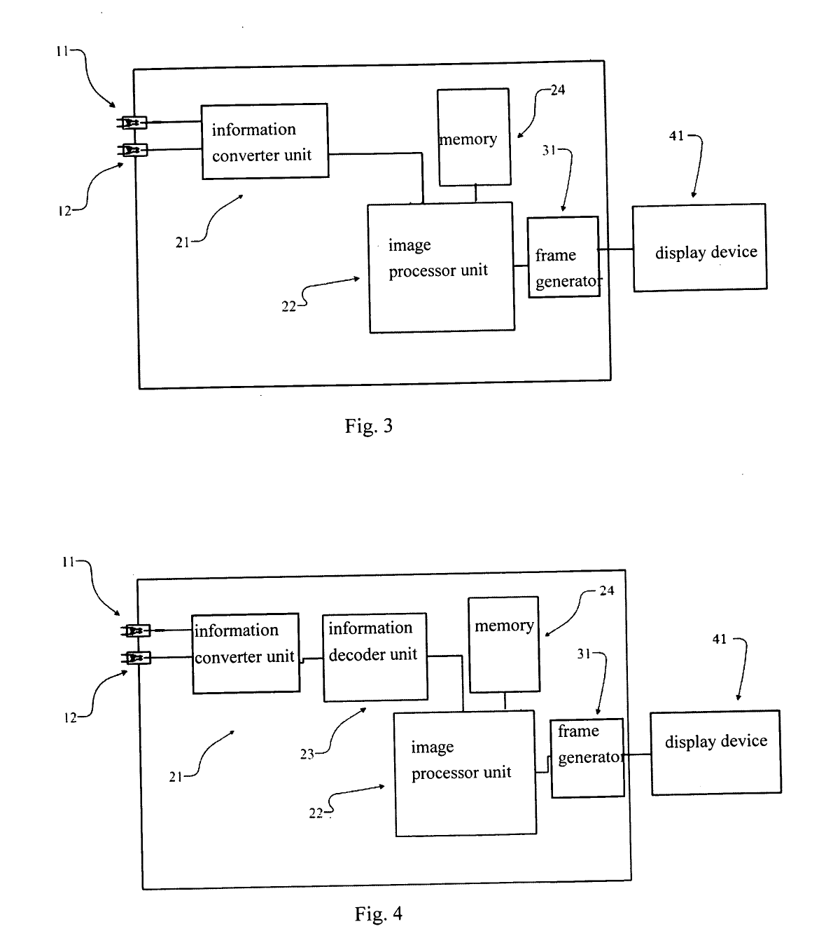

FIG. 3 shows the block diagram of the third embodiment of the display controller for screens with user-defined frames of the present invention. In this figure the components identical to those in FIG. 1 are labeled with the same reference numbers. As shown in the figure, the structure of the display controller in this embodiment is similar with that of the Embodiment 1. The differences include that a memory 24 is provided in the display controller, to function as a buffer memory for the image data to be added. FIG. 3 shows that the memory 24 is connected to the image processor unit 22. In the adding operations of the image processor unit 22, the memory 24 works as its buffer memory. In this embodiment the memory 24 is a dynamic random access memory.

### Embodiment 4

FIG. 4 shows the block diagram of the fourth embodiment of the display controller for screens with user-defined frames of the present invention. In this figure the components identical to those in FIG. 2 are labeled with the same reference numbers. As shown in the figure, the structure of the display controller in this embodiment is similar with that of the Embodiment 2. The differences include that a memory 24 is provided in the display device 41, to function as a buffer memory for the image data to be added. FIG. 4 shows that the memory 24 is connected to the image processor unit 22. In the adding operations of the image processor unit 22, the memory 24 works as its buffer memory. In this embodiment the memory 24 is a dynamic random access memory.

### Embodiment 5

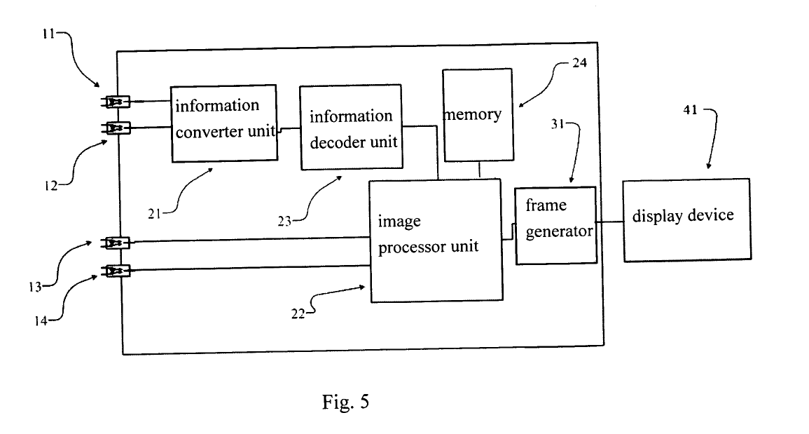

FIG. 5 shows the block diagram of the fifth embodiment of the display controller for screens with user-defined frames of the present invention. In this figure the components identical to those in FIG. 1 are labeled with the same reference numbers. As shown in the figure, in this first embodiment, the display controller for screens with user-defined frames of the present invention includes a first image source 11, a second image source 12, a third image source 13, a fourth image source 14, an information converter unit 21, an information decoder unit 23, an image processor unit 22 and a frame generator 31 and is connected to a display device 41. In them, the first image source 11 and the second image source 12 are separately connected to one terminal of the information converter unit 21, with its other terminal connected to the information decoder unit 23. The third image source 13 and the fourth image source 14 are respectively connected to one terminal of the image processor unit 22, with its other terminal being connected to the information decoder unit 23. The frame generator 31 is also connected to the image processor unit 22. In this embodiment, the display unit 41 is a liquid display panel.

The first image data are provided through the first image source 11, the second image data are provided through the second image source 12, the third image data are provided through the third image source 13 and the fourth image data are provided through the fourth image source 14. In the present embodiment both the first and second image data are video signals. When the first and second image data enter the display controller, they are first provided to the information converter unit 21 to be converted into digital data. Also in this embodiment the information converter unit 21 is an analog-to-digital converter.

Thereafter, the digitized image data are provided to the information decoder 23 for decoding. In this embodiment the information decoder unit is a video signal decoder. In the following, the decoded first and second image data are provided to the image processor unit 22, to conduct the adding operations.

The frame generator 31 is able to generate, according to the instructions of the user or the predetermined parameters, a frame to define the border of the first image data and the second image data when they are displayed in the display device.

The decoded first image data and second image data, and the third and fourth image data that were provided directly from the third image source 13 and the fourth image source 14, respectively, are added in the image processor unit 22. In this embodiment, the image processor unit 22 is a PIP image processing unit. The PIP image processing unit 22 of this embodiment conducts the adding operations of the first image data, the second image data, the third image data, the fourth image data and the frames generated by the frame generator 31, so to generate the PIP images with the user-defined frames, to be displayed in the display device 41.

Lastly, the added image is provided to the display device 41 for display. The display device 41 displays the PIP image with the main screen and the subscreens with the user-defined frames. The image as added by the image processor unit 22 has a main screen and three subscreens in it. The subscreens respectively have a frame with the dynamically variant shape, a scalable shape or a randomly selected shape.

### Embodiment 6

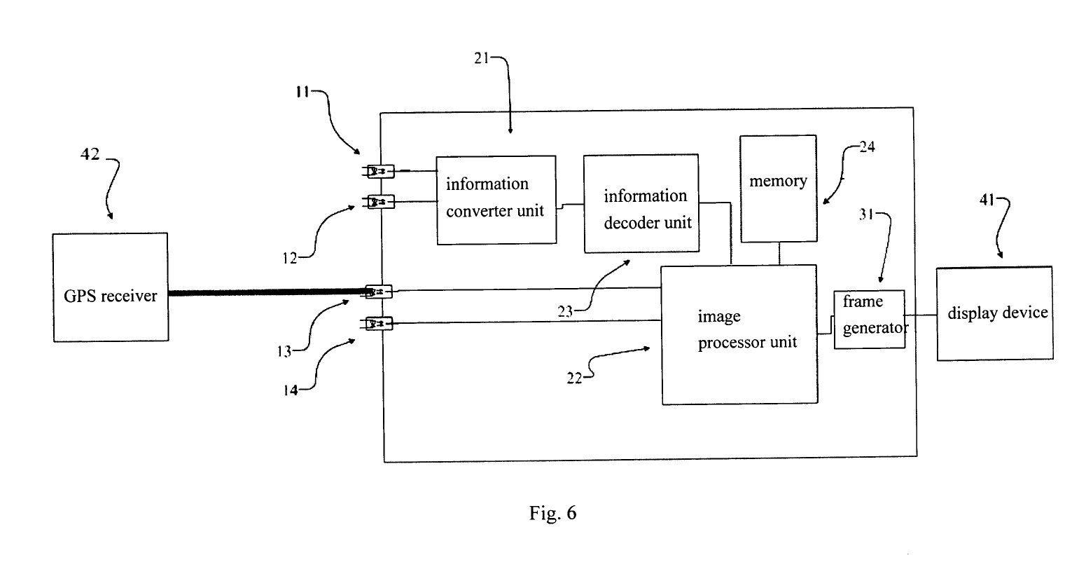

FIG. 6 shows the block diagram of the sixth embodiment of the display controller for screens with user-defined frames of the present invention. In this figure the components identical to those in FIG. 5 are labeled with the same reference numbers. As shown in the figure, the structure of the display controller in this embodiment is similar with that of the Embodiment 5. The differences include that the display controller further includes a GPS receiver 42. FIG. 6 shows that the GPS receiver 42 is connected to the third image source 13 and is able to receive the global positioning information generated by a satellite (not shown) and to generate the global positioning information in a digital format. In other words, the GPS receiver 42 generates the third image data and provides the data to the third image source 13.

### Embodiment 7

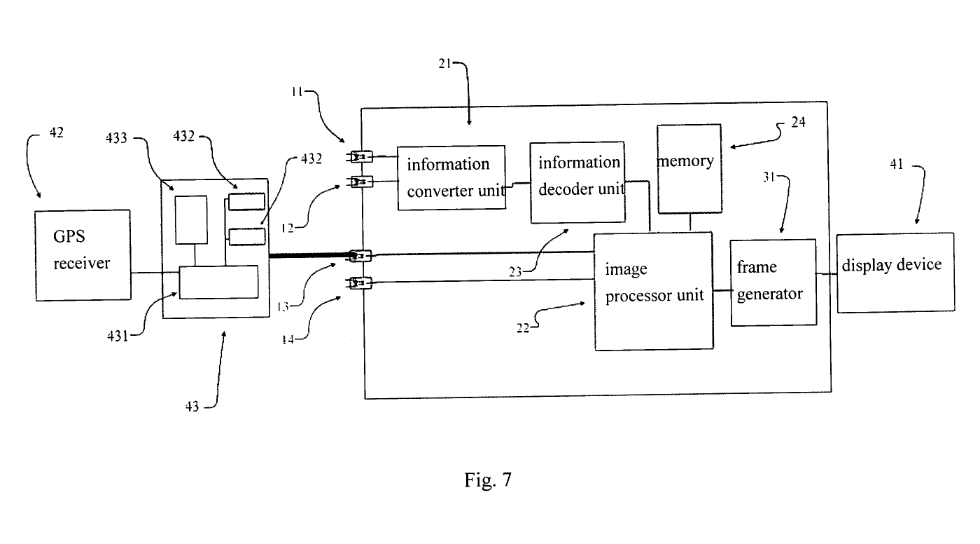

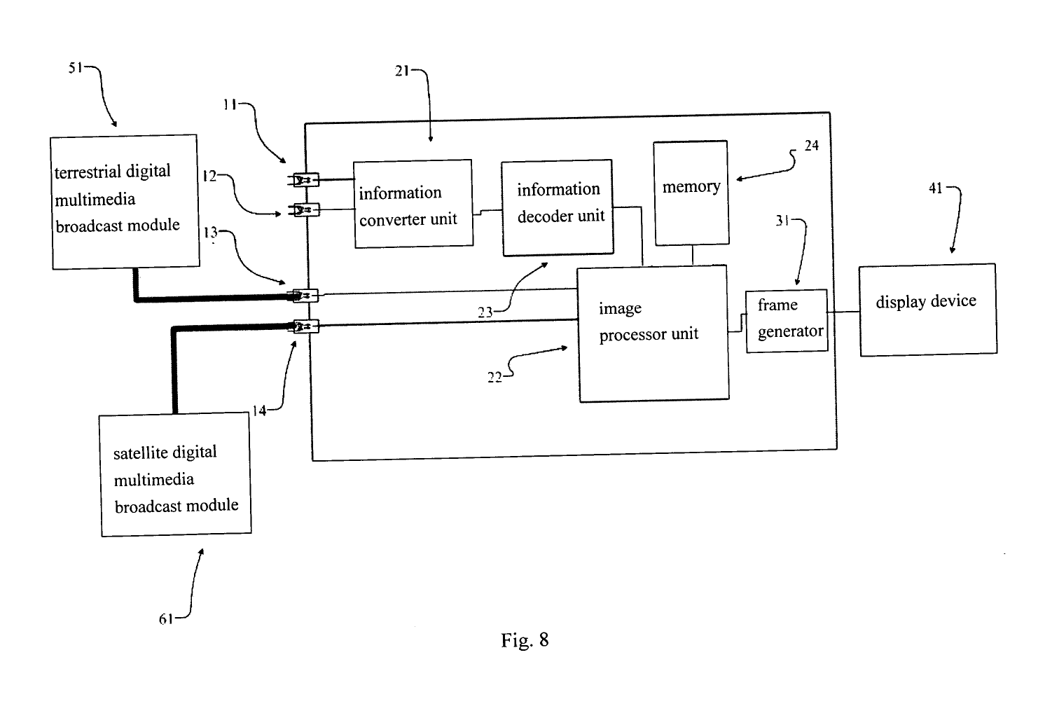

FIG. 7 shows the block diagram of the seventh embodiment of the display controller for screens with user-defined frames of the present invention. In this figure the components identical to those in FIG. 6 are labeled with the same reference numbers. As shown in the figure, the structure of the display controller in this embodiment is similar with that of the Embodiment 6. The differences include that the display controller further includes an operational processor 43. FIG. 7 shows that the operational processor 43 is in connection with the GPS receiver 42 and the third image source 13. The operational processor includes a central processing unit 431, 2 dynamic ransom access memories 432, 432 and a NAND flash memory 433. The a central processing unit 431 is in connection with the 2 dynamic ransom access memories 432, 432 and the NAND flash memory 433.

The GPS receiver 42 is able to receive the global positioning information generated by a satellite (not shown). The global positioning information is provided to the operational processor 43 for processing and is output in a digital format. In other words, the combination of the GPS receiver 42 and the operational processor 43 helps to accelerate the processing of the third image data, which are provided to the third image source 13 after processing.

### Embodiment 8

FIG. 8 shows the block diagram of the eighth embodiment of the display controller for screens with user-defined frames of the present invention. In this figure the components identical to those in FIG. 5 are labeled with the same reference numbers. As shown in the figure, the structure of the display controller in this embodiment is similar with that of the Embodiment 5. The differences include that the display controller further includes two sets of digital multimedia broadcast modules 51, 61, including a terrestrial digital multimedia broadcast module 51 and a satellite digital multimedia broadcast module 61. In addition, the digital multimedia broadcast modules 51, 61 are connected with the third image source 131 and the fourth image source 14, respectively. The figure shows that in this embodiment the terrestrial digital multimedia broadcast module 51 is in connection with the third image source 13 and the satellite digital multimedia broadcast module 61 is in connection with the fourth image source.

### Embodiment 9

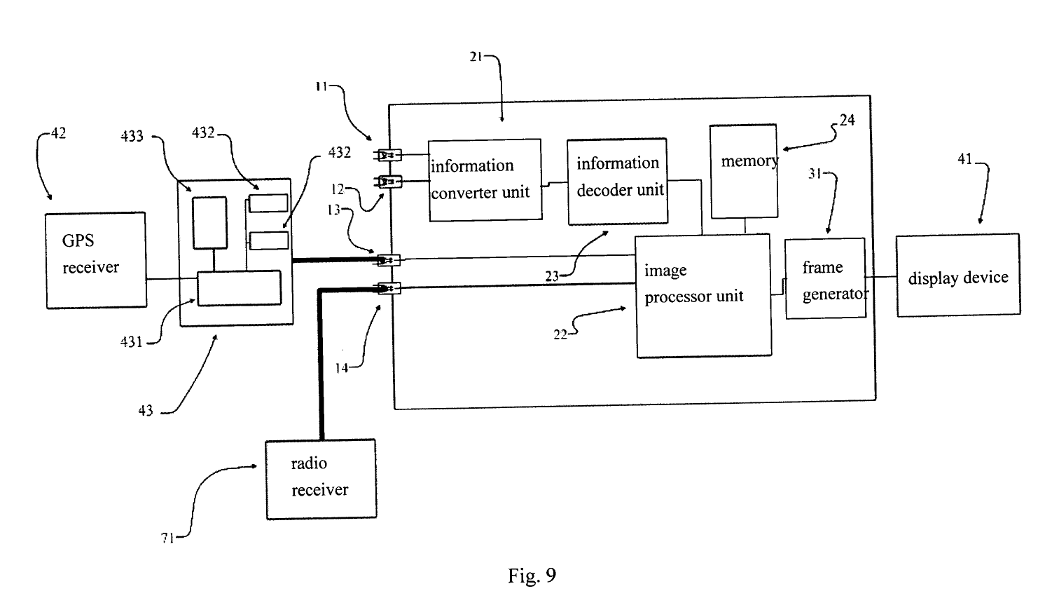

FIG. 9 shows the block diagram of the ninth embodiment of the display controller for screens with user-defined frames of the present invention. In this figure the components identical to those in FIG. 7 are labeled with the same reference numbers. As shown in the figure, the structure of the display controller in this embodiment is similar with that of the Embodiment 7. The differences include that the display controller further includes a radio receiver 71. The figure shows that in this embodiment the radio receiver 71 is in connection with the fourth image source. The radio receiver may be an AM radio receiver, an FM radio receiver, an AM/FM radio receiver, or a digital multimedia receiver.

### Embodiment 10

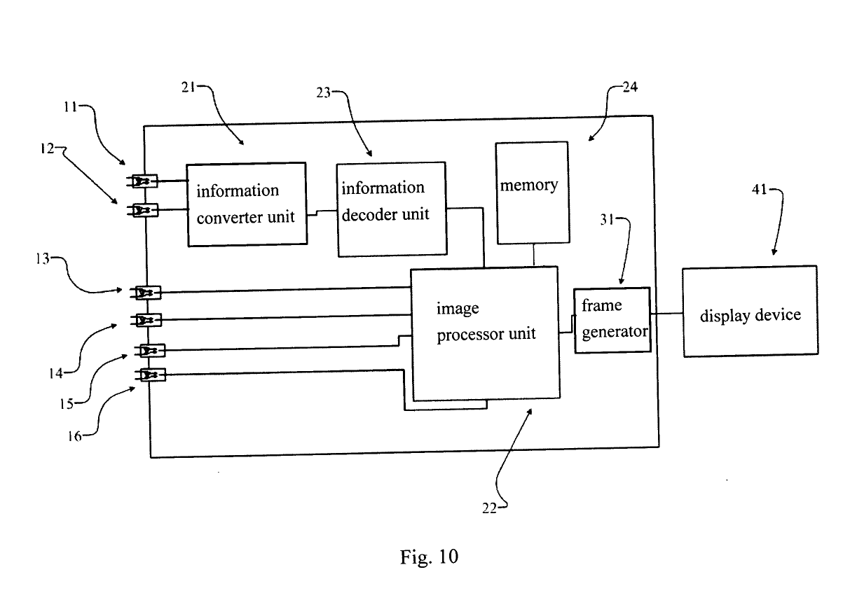

FIG. 10 shows the block diagram of the ninth embodiment of the display controller for screens with user-defined frames of the present invention. In this figure the components identical to those in FIG. 5 are labeled with the same reference numbers. As shown in the figure, the structure of the display controller in this embodiment is similar with that of the Embodiment 5. The differences include that the display controller in this embodiment is able to display the contents of the main screen, penetrating the subscreens overlaying them. In addition, the display controller of this embodiment further includes a fifth image source and a sixth image source. Here, to display the contents of the main screen in penetration of the overlaying subscreen has been a technology known to those skilled in the art. Detailed description thereof is thus omitted.

As described above, the display controller for screens with user-defined frames of the present invention has provided several outstanding functions. It is able to generate in the displaying device the PIP images with frames that is selectable, variable and scalable. In addition, the contents of the main screen may be displayed in penetration of the overlaying subscreens.

As the present invention has been shown and described with reference to preferred embodiments thereof, those skilled in the art will recognize that the above and other changes may be made therein without departing form the spirit and scope of the invention.

What is claimed is:

1. A display controller for screens with user-defined frames, comprising:
a first image source to provide first image data;
a second image source to provide second image data;
an information converter unit in connection with said first and second image sources, to convert said first and second image data into digital data;
an image processor unit in connection with said information converter unit to add said digitized first and second image data, to generate a picture-in-picture (PIP) image with one main screen and at least one subscreen to be display in a display device; and
a frame generator to generate, according to the definitions of a user, a frame for said at least one subscreen to enclose said subscreen when displayed.

2. The display controller for screens with user-defined frames according to claim 1, further comprising a display device to display said PIP image.

3. The display controller for screens with user-defined frames according to claim 2, wherein said display device comprises a display panel selected from the group consisted of a liquid crystal display panel and a thin film transistor liquid crystal display panel.

4. The display controller for screens with user-defined frames according to claim 2, wherein said display device further comprises a memory to function as buffer memory for image data to be added by said information converter unit.

5. The display controller for screens with user-defined frames according to claim 2, wherein said memory is a dynamic random access memory.

6. The display controller for screens with user-defined frames according to claim 1, wherein said first image data and said second image data are one selected from the group consisted of a video signal, a video-audio signal and an image signal containing text information.

7. The display controller for screens with user-defined frames according to claim 1, further comprising an information decoder unit to decode said digitized first and second image data.

8. The display controller for screens with user-defined frames according to claim 7, wherein said information decoder unit comprises a video signal decoder.

9. The display controller for screens with user-defined frames according to claim 1, wherein said information converter unit comprises an analog-to-digital converter.

10. The display controller for screens with user-defined frames according to claim 1, wherein said image processor unit comprises a PIP image processor.

11. The display controller for screens with user-defined frames according to claim 1, wherein the frame generated by said frame generator comprises a dynamically variable shape.

12. The display controller for screens with user-defined frames according to claim 1, wherein the frame generated by said frame generator comprises a scalable shape.

13. The display controller for screens with user-defined frames according to claim 1, further comprising a memory to function as buffer memory for image data to be added by said information converter unit.

14. The display controller for screens with user-defined frames according to claim 13, wherein said memory is a dynamic random access memory.

15. The display controller for screens with user-defined frames according to claim 1, further comprising a third image source to provide a third image data, wherein said third image data is digital data.

16. The display controller for screens with user-defined frames according to claim 15, further comprising a GPS receiver in connection with said third image source to provide said third image data.

17. The display controller for screens with user-defined frames according to claim 15, further comprising a GPS receiver and an operational processor module to provide said third image data.

18. The display controller for screens with user-defined frames according to claim 17, wherein said GPS receiver is connected to said operational processor module and said operational processor module is connected to said third image source.

19. The display controller for screens with user-defined frames according to claim 17, wherein said operational processor module comprises an operational processor, 2 dynamic random access memories, and a NAND flash memory, wherein said operational processor is in connection with said 2 dynamic random access memories and said NAND flash memory.

20. The display controller for screens with user-defined frames according to claim 15, further comprising a terrestrial digital multimedia broadcast module in connection with said third image source to generate said third image data.

21. The display controller for screens with user-defined frames according to claim 15, further comprising a satellite digital multimedia broadcast module in connection with said third image source to generate said third image data.
